(19) United States
(12) Patent Application Publication
(10) Pub. No.: US 2005/0101346 A1
(43) Pub. Date: May 12, 2005

(54) Receiver device and method using GPS baseband correlator circuitry for despreading both GPS and local wireless baseband signals

(76) Inventors: Steve Wozniak, Los Gatos, CA (US); Dimitri Rubin, Cupertino, CA (US)

Correspondence Address: WAGNER, MURABITO & HAO LLP, Third Floor, Two North Market Street, San Jose, CA, 95113, US

(21) Appl. No.: 10/703,348

(22) Filed: Nov. 7, 2003

(51) Int. Cl. H04B 1/00; H04B 1/06; H04B 7/00

(52) U.S. Cl. 455/552.1; 455/132; 455/277.1

(57) ABSTRACT

A method and system using correlator circuitry in a GPS baseband circuit for despreading both GPS data and local wireless data. In one embodiment, an RF signal (local wireless) is received at a first frequency and a digital baseband signal is produced therefrom at a second frequency. A GPS signal is also received at the second frequency and a digital baseband signal is produced therefrom. Both baseband signals are provided to a single GPS baseband circuit for data recovery. In a GPS mode, GPS data is recovered from the baseband signal by despreading and demodulation. In a local wireless mode, the GPS baseband circuit is programmed to despread and recover local wireless data. The GPS data and the local wireless data can be stored in a data buffer for downstream processing. By sharing the correlator circuits in the GPS baseband circuit for both GPS data recovery and local wireless data recovery, a low cost receiver unit is provided. In one embodiment, the local wireless baseband signal is produced by up conversion of the local wireless RF signal and then processing though a common RF front-end circuit that is also used by the received GPS signal.

### RELATED US PATENT APPLICATION

The present application claims benefit to co-pending U.S. provisional patent application Ser. No. ______ , filed on Sep. 21, 2003, titled “GPS BASEBAND CORRELATOR CIRCUITRY FOR DESPREADING BOTH GPS AND LOCAL WIRELESS BASEBAND SIGNALS,” by Wozniak, et. al, attorney docket number WOZN-P2005.PRO, which is also hereby incorporated by reference.

### BACKGROUND OF THE INVENTION

1. Field of the Invention

Embodiments of the present invention relate to the field of wireless communication. More specifically, embodiments of the present invention relate to a receiver circuit for receiving both global positioning system (GPS) data and local wireless data.

2. Related Art

Global positioning system (GPS) devices communicate with orbiting satellites (and/or terrestrial based reference systems) to determine a global location of the device. Position information can be obtained in this manner, in part, by measuring timing differences in the communication signals made between various satellites (and/or terrestrial systems) and the device using wireless communication links. A GPS device using such a location system may be hand-held. GPS data communicated over wireless links uses a technique called direct sequence spread spectrum in order to accurately broadcast a weak signal over a long distance.

GPS uses a Code Division Multiple Access (CDMA) Direct Sequence Spread Spectrum (DSSS) technique. The GPS signal is information bits spread by orthogonal binary 1023 bit code, often called “gold code”. In the current generation of GPS, the same information bit is repeated 20 times and up converted to the “L1” frequency which is 1.57542 Ghz. By using this spread spectrum communication technique, the wireless communication link becomes very resistant to noise and can be broadcast over vast distances, as is well known. When the 1.57542 GHz GPS signal is received, it is fed to an RF front-end circuit which is down converts it to a digital baseband signal. A GPS baseband circuit receives this digital baseband signal, despreads and demodulates the signal to recover the GPS data. Correlator circuits of the GPS baseband circuit are used to perform the despreading function according to well known methods.

GPS devices also may communicate wirelessly with other GPS devices or local devices to perform various functions, such as locating a device using another device. GPS devices use radio or RF signals when communicating in this fashion. This is called local wireless communication and refers to GPS devices communicating with other local devices.

Prior art GPS devices utilize two separate receiver subsystems for receiving GPS and local wireless information. Typically, a 1.57542 GHz receiver is used for receiving and recovering GPS data and a separate radio receiver is used for receiving and recovering local wireless data. The receivers are typically maintained as separate because of the different frequencies and communication protocols involved between GPS and local wireless data. This is true for devices capable of both GPS and cellular communication, GPS and radio communication and GPS and pager communication. Unfortunately, by using two separate receiver systems, the cost and complexity of these GPS devices increases and this poses problems for developers of low cost GPS devices. It would be advantageous to provide a very inexpensive device having both GPS and local wireless communication. Such device could, for example, be placed on objects for the tracking thereof.

### SUMMARY OF THE INVENTION

Accordingly, embodiments of the present invention provide a GPS and local wireless data receiver that share components in common thereby reducing the cost and complexity of the overall receiver unit. More specifically, the GPS baseband circuit of the present invention can be used for recovering local wireless data as well as recovering GPS data. By using the GPS baseband circuit for recovery of local wireless data, an embodiment of the present invention makes use of a very low cost RF receiver circuit for the local wireless path thereby allowing a low cost GPS/local wireless receiver solution. In one implementation, the present invention provides a very inexpensive device, e.g., “tag device,” having both GPS and local wireless communication. Such device could, for example, be placed on objects for the tracking thereof. The inexpensive receiver system could also be implemented within a “finder device” as described further below, for communicating with and locating tag devices.

Embodiments of the present invention are directed to a method and system using a GPS baseband circuit for despreading both GPS data and local wireless data. In one embodiment, an RF signal (local wireless) is received at a first frequency and a digital baseband signal is produced therefrom at a second frequency. A GPS signal is also received at the second frequency and a digital baseband signal is produced therefrom. Both baseband signals are provided to a single GPS baseband circuit for data recovery. In a GPS mode, GPS data is recovered from the baseband signal by despreading and demodulation. In a local wireless mode, the GPS baseband circuit is programmed to despread and recover local wireless data. The GPS data and the local wireless data can be stored in a data buffer for downstream processing. By sharing the correlator circuits in the GPS baseband circuit for both GPS data recovery and local wireless data recovery, a low cost receiver unit is provided. In one embodiment, the local wireless baseband signal is produced by up conversion of the local wireless RF signal and then processing though a common RF front-end circuit that is also used by the received GPS signal.

More specifically, in one embodiment a receiver device is described that contains a receiver circuit for coupling with an antenna and for producing an analog global positioning system (GPS) signal therefrom having a first frequency. The receiver device also contains a radio frequency (RF) front-end circuit for receiving the analog GPS signal and for producing a GPS baseband signal therefrom. The receiver device also contains a low cost receiver circuit for coupling with an antenna and for producing a first analog local wireless (LW) signal therefrom having a second frequency. The receiver device also contains a frequency converter circuit coupled to the low cost receiver circuit and for converting the first analog LW signal to a second analog LW signal having the first frequency, wherein the RF front-end circuit also receives the second analog LW signal and produces an LW baseband signal therefrom. The receiver device also contains a baseband circuit for receiving both the GPS and the LW baseband signals and recovering therefrom GPS and LW data. In one implementation, the first frequency is substantially 1.57542 GHz and the second frequency is substantially 900 MHz. In another embodiment, the baseband circuit is operable in a first mode wherein correlator circuitry of the baseband circuit despreads the LW baseband signal and the baseband circuit is also operable in a second mode wherein the correlator circuitry despreads the GPS baseband signal. An RF switch, coupled to receive the analog GPS signal and the second analog LW signal, may be used for passing through the second analog LW signal to the RF front-end circuit during the first mode and for passing through the analog GPS signal to the RF front-end circuit during the second mode.

In another embodiment, a receiver device is described that contains a first radio frequency (RF) front-end circuit for producing a GPS baseband signal from a received wireless analog GPS signal. The receiver device also contains a second RF front-end circuit for producing a local wireless (LW) baseband signal from a received wireless analog LW signal. The receiver device also contains a common baseband circuit for receiving both the GPS and the LW baseband signals and for recovering therefrom GPS and LW digital data. In one embodiment, the received GPS signal is substantially 1.57542 GHz in frequency and the received wireless analog LW signal has a frequency of substantially 900 MHz. In one embodiment, the common baseband circuit comprises common correlator circuitry that is used for despreading both the GPS the LW baseband signals for recovering digital data therefrom and further the common baseband circuit is operable in a first mode wherein the common correlator circuitry despreads the LW baseband signal and is operable in a second mode wherein the common correlator circuitry despreads the GPS baseband signal. In one embodiment, the receiver device also contains a switch coupled to receive signals from the first and second RF front-end circuits and coupled to supply signals to the common baseband circuit, the switch for passing through the LW baseband signal during the first mode and for passing through the GPS baseband signal during the second mode.

Embodiments of the present invention also include methods of operating the receivers as described above.

### BRIEF DESCRIPTION OF THE DRAWINGS

FIG. 1 illustrates a system in which receiver embodiments of the present invention may be employed in a finder unit and/or in a tag unit for receiving both GPS wireless data and local wireless data.

FIG. 2 is a circuit diagram of a GPS/Local Wireless receiver unit in accordance with one embodiment of the present invention employing local wireless RF signal upconversion and common RF front-end and baseband circuits.

FIG. 3A is a circuit diagram of a GPS/Local Wireless receiver unit in accordance with another embodiment of the present invention employing two RF front-end circuits for producing two baseband digital signals.

FIG. 3B is a circuit diagram of a GPS/Local Wireless receiver unit in accordance with another embodiment of the present invention employing a single RF front-end circuit that is frequency tunable and a common baseband circuit.

FIG. 4 is a block diagram of a baseband circuit in accordance with an embodiment of the present invention employing a shared correlator circuit for recovering both GPS data and local wireless data.

FIG. 5 is a block diagram of a correlator circuit in accidence with an embodiment of the present invention for performing despreading to recover both GPS data and local wireless data.

FIG. 6 is an exemplary flow diagram of a process in accordance with one embodiment of the present invention for up converting a local wireless RF signal so that a GPS baseband circuit can be used for recovery of local wireless data therefrom-in accordance with the receiver circuit of FIG. 2.

FIG. 7 is an exemplary flow diagram of a process in accordance with another embodiment of the present invention for the correlator circuit of a single baseband circuit for recovery of both GPS and local wireless data in accordance with the receiver circuits of FIG. 2 and FIG. 3A.

### DETAILED DESCRIPTION OF THE INVENTION

Reference will now be made in detail to the preferred embodiments of the present invention, a method and system are described for implementing a receive device for local wireless signals using GPS baseband correlator circuits, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the present invention.

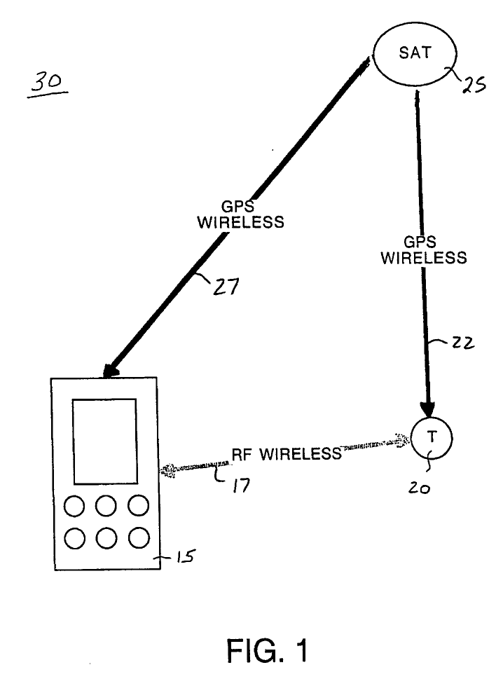

FIG. 1 illustrates an exemplary communication system 30 in which embodiments of the present invention may be practiced. It is appreciated that embodiments of the present invention are directed to a receiver device capable of receiving global positioning system (GPS) wireless signals and local wireless signals. Such a receiver device can be used in any communication system configuration having need for these signals. Exemplary system 30 is but one example of such a system and is shown for purposes of illustration and discussion only.

In system 30 of FIG. 1, a locator device 15 or “finder,” receives a signal from a wireless link 27 with one or more GPS satellites 25, or terrestrial based referenced systems (not shown), to obtain GPS related position information of the device 15. As shown, device 15 is a hand-held electronic device, but could be a stationary or otherwise desktop device. GPS wireless link 27 may be of a number of well known types using a number of different well known GPS communication protocols and frequencies. Typically, GPS communication protocols utilize direct sequence spread spectrum techniques for data spreading and further may utilize other forms of modulation, all of which are very well known in the art. These techniques allow a relatively weak signal and low power signal to be broadcast over long distances and offer excellent noise suppression and accurate recovery. These techniques also allow a number of different satellites (and terrestrial based GPS systems) to broadcast their data over the same frequency as each one's signal appears as noise to the others. In one embodiment of the present invention, GPS wireless communication link 27 utilizes a standard frequency of 1.57542 GHz, but could be any acceptable and used GPS frequency.

The locator or finder device 15 also may communicate over a radio frequency (RF) wireless link 17 to another GPS device 20, called herein the “tag device.” This communication link 17 is referred to herein as the local wireless (LW) communication link 17 and may be bidirectional. This communication link 17 can be of any frequency, but in one embodiment, it is an RF frequency, e.g., 900 MHz. Any of a number of different RF frequencies can be used as the RF frequency, e.g., 400 MHz, 868 MHz, 2400 MHz, 27 MHz, etc., and 900 MHz is merely exemplary. The tag devices 20 may be placed on objects for tracking their locations. The finder device 15 may communicate requests to the tag 20, over LW link 17, such as “where are you?” The tag 20, in response, may communicate its location to the finder 15 over LW link 17, or may communicate a signal that it is lost, for instance. The tag 20 may also communicate a signal to the finder 15, over LW link 17, in response to some event that it has detected or computed, such as, it was moved outside a prescribed boundary, or that it is moving at a predetermined speed or direction, etc. Like the finder 15, the tag 20, may receive a signal from the GPS based systems 25 using a GPS wireless link 22, similar to link 27, to obtain its location information.

It is appreciated that when tags 20 communicate with each other (not shown), this communication may also be categorized herein as an LW communication. Further, when finder devices 15 communicate with each other (not shown), this communication may also be categorized herein as an LW communication.

As shown in FIG. 1, the finder device 15 and the tag device 20 each contain receiver circuitry for receiving both a GPS based wireless communication (e.g., links 27 and 22) and a local wireless (LW) communication, e.g., link 17. Digital data may be broadcast over these communication links. While the GPS wireless communications adhere to well known and standardized communication protocols and frequencies, the local wireless communications links may be of any suitable frequency or communication protocol. As described further below, embodiments of the present invention are directed to a low cost receiver circuit for receiving signals from both GPS and LW communication links. This so called GPS/LW receiver circuit may be utilized in the finder device 15 and/or the tag device 20, for instance. By implementing a low cost, and low power receiver solution, inexpensive and low power tag devices 20 may be provided.

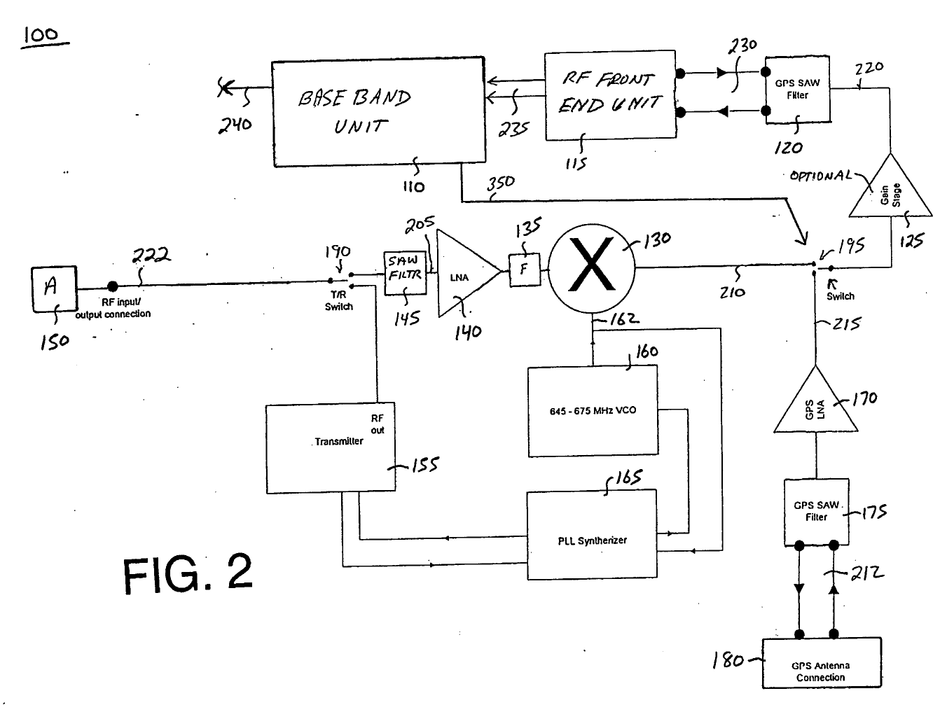

FIG. 2 illustrates a GPS/LW receiver circuit 100 in accordance with one embodiment of the present invention. Circuit 100, as described further below, advantageously utilizes correlator circuits within a baseband circuit 110 for despreading both GPS and LW communication, thereby significantly reducing the cost of the receiver subsystem required to receive LW communication. In general, the circuitry normally used to merely receive and recover GPS information is advantageously used for also receiving and recovering LW information, in accordance with embodiments of the present invention.

The LW receiver path of circuit 100 is now described. As shown in FIG. 2, an RF antenna 150 is connected to an optional saw filter circuit 145 using connection 222 and switch 190. Any well known RF antenna design can be used for receiving RF signals, e.g., over LW communication link 17 (FIG. 1). The saw filter circuit 145 of FIG. 2 performs signal filtering allowing only specified signals through. In one embodiment of the present invention, the received LW analog signal is 900 MHz, but could be of any RF frequency. In one particular implementation, a −1.5 dB filter is used for circuit 145.

The saw filter circuit 145 is connected to a low cost LW receiver circuit, which in the exemplary embodiment shown in FIG. 2, is a low noise amplifier (LNA) circuit 140. In the example shown, this connection is made through a transmit/receive switch 190, which in this description may be assumed to be set in the receive mode thus connecting the RF input 222 to the filter 145 and bypassing transmitter circuit 155. Any of a number of well known, low cost LNA circuits may be used, but in one particular implementation, an LNA circuit having a Gmax of 18 dB and an NF of 2.0 dB may be used. It is appreciated that in one implementation, the LNA circuit 140 is not generally a full receiver circuit in the traditional description, but rather a low cost receiver circuit for boosting the LW signal in the 900 MHz range. The LNA circuit 140 amplifies an analog LW signal at a frequency of 900 MHz, which optionally may be fed to a filter 135 to eliminate unwanted frequencies, as needed.

Circuit 130, 160, and 165 in combination upconverts the analog LW signal to the frequency of the GPS communication link. Mixer circuit 130, voltage controlled oscillator (VCO) circuit 160 and phase locked loop (PLL) synthesizer circuit 165 function together to provide a 600 MHz signal (at 162) that is mixed with the analog LW signal provided by LNA circuit 140 (and optionally filtered by 135). By mixing the 900 MHz LW signal with the 600 MHz signal, circuits 130, 160 and 165 operate together, in a well known manner, to upconvert the analog LW signal to 1.57542 GHz, which is the GPS frequency as described herein. Optionally, these circuits 160 and 165 may also be used by transmitter circuitry 155. Although any of a number of well known upconverter circuits can be used, mixer 130 has a Gmax of 8 dB and an NF of 10 dB in one example. Circuits 130, 160 and 165 function as a frequency converter and produce an LW analog signal at 210 having 1.57542 GHz frequency. It is appreciated that, in accordance with this embodiment, the particular frequency produced at 210 may be any frequency that matches that of the GPS communication frequency. In the illustrated embodiment, this happens to be 1.57542 GHz, for discussion. The LW analog signal at 210 is then provided to an input leg of an analog switch 195 which switches between the LW receiver path and the GPS receiver path.

It is appreciated that 900 MHz is but one LW frequency that can be used and is discussed herein as an exemplary frequency. In situations where a higher frequency is used for the LW leg, the up conversion discussed above may actually be a down conversion, e.g., cases in which the LW frequency is actually higher than the GPS frequency.

The GPS receiver path of circuit 100 is now described. As shown in FIG. 2, a GPS antenna 180 is connected to an optional saw filter circuit 175 using connection 212. Any well known antenna design can be used for receiving GPS signals, e.g., over GPS communication links 22 and 27 (FIG. 1). The GPS saw filter circuit 175 of FIG. 2 performs signal cleaning allowing only specified signals through. In one embodiment of the present invention, the received GPS analog signal is 1.57542 GHz, but could be of any acceptable GPS standardized frequency. In one particular implementation, a −1.5 dB filter is used as circuit 175. The saw filter circuit 175 is connected to a GPS low noise amplifier (LNA) circuit 170. Any of a number of well known GPS LNA circuits may be used, but in one particular implementation, an LNA circuit having a Gmax of 26 dB and an NF of 1.5 dB may be used for circuit 170. LNA circuit 170 produces a GPS analog signal of 1.57542 GHz at line 215 and is coupled to the other input leg of switch 195.

Switch 195 has an output leg that is coupled to an optional gain stage circuit 125. Switch 195 is controlled by a signal over line 350 that toggles between “LW receive mode” and “GPS receive mode.” In GPS receive mode, the GPS analog signal of 215 is supplied to circuit 125 and in LW receive mode, the LW analog signal of 210 is supplied to circuit 125. Gain stage 125 is optional and may have Gmax=12 dB and NF=3.0 dB in accordance with one implementation. The output of circuit 125 is coupled to another GPS saw filter 120 (e.g., −1.5 dB) which provides a filtered analog signal (GPS or LW) to the input of an RF front-end unit 115. In operation, GPS and LW analog signals of 1.57542 MHz are time multiplexed over line 230 under control of switch 195 depending on the type of information desired.

Any of a number of well known RF front-end units may be used as circuit 115 but in one embodiment a U-Nav 8021 GPS radio chip may be used. RF front-end unit 115, in this embodiment, is shared by the GPS and LW receive paths and produces a baseband signal over lines 235 to a baseband unit 110. In the GPS receive mode, the baseband signal over lines 235 is the GPS baseband signal and is generally digital. In the LW receive mode, the baseband signal over lines 235 is the LW baseband signal and is generally digital.

FIG. 2 illustrates baseband circuit 110 controlling the state of switch control line 350, e.g., via a controller or processor. It appreciated that any type of control circuit can control the mode signal over line 350 and the embodiment shown in FIG. 2 is merely exemplary. Baseband circuit 110 provides recovered digital GPS data and recovered LW digital data over line 240 for downstream processing. Alternatively, this digital data may be consumed by processors and logic within the baseband circuit 110.

When in the GPS mode of operation, the baseband circuit 110 operates according to well known standard GPS baseband functionality for despreading and demodulating the GPS baseband signal according to well known and standard GPS communication protocols, which include decoding signals that are encoded using direct sequence spread spectrum techniques, for instance. As is well known, correlator circuits are used to recover GPS data from a GPS baseband signal of lines 235.

When in the LW mode of operation, baseband circuit 110 advantageously shares the correlator circuits to also recover LW data that may be encoded using direct sequence spread spectrum techniques. By spreading the LW data in this fashion at the transmitter, the present invention is able to provide an RF signal (carrying LW information) that can be received over long distances, uses relatively little power and provides excellent noise suppression and channel sharing capabilities. In one embodiment, standard GPS communication protocol can be used for encoding (and recovering) the LW data thereby requiring little, of any, changes in conventional GPS baseband circuits for the recovery of the LW data.

In other embodiments, the communication protocol for LW data may be altered in an optimization which eliminates much of the GPS overhead that may not be required to communicate LW data. Furthermore, in standard GPS communication techniques, it is common to repeat (e.g. 20 repetitions) the same symbol spread with a 1023 bit sequence (or gold code) to represent a single information bit, 1 or 0. This technique can be eliminated or significantly reduced when communicating LW data. For instance, an LW bit can be encoded using direct sequence spread spectrum techniques, but only a single transmission of its “gold code” (or inverse) is used to transmit the bit when in LW mode. Of course, this alternative requires slight modifications to the standard GPS baseband data recovery programming and represents an optimization for LW communication. In either alternative described above, the correlator circuits of the baseband circuit 110 are advantageously used for data recovery of LW digital data and also for GPS digital data.

By advantageously using GPS type signal encoding and protocol for LW signals and further by sharing the GPS baseband circuitry (including correlators) for recovering this data, receiver circuit 100 of the present invention is sensitive to LW RF signals of approximately −135 dBm while using a very low cost, low power, LW receiver circuit and little, if any, required changes of the GPS baseband circuit.

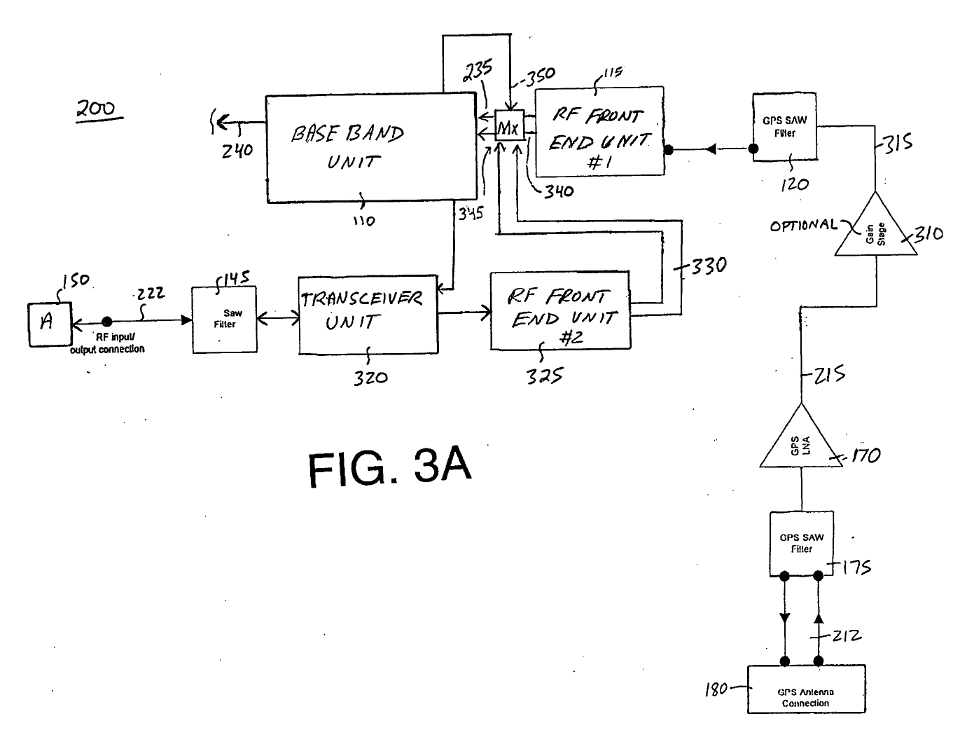

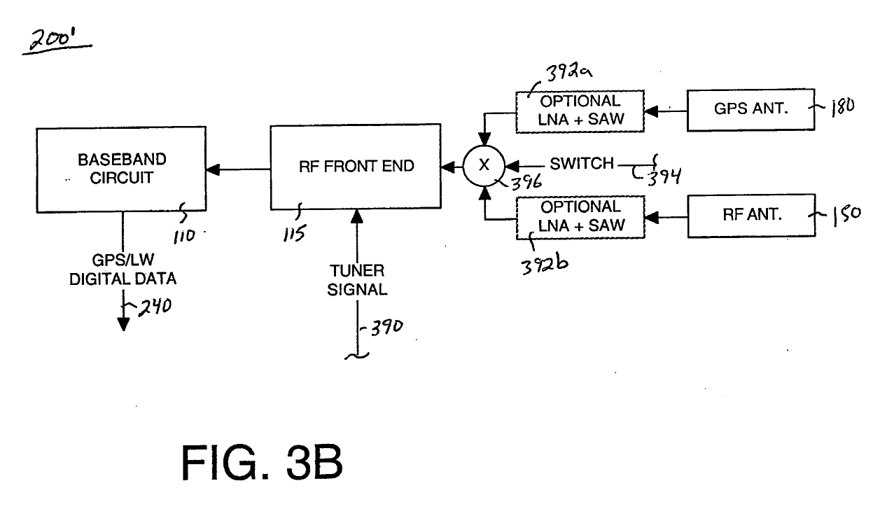

FIG. 3A illustrates another embodiment 200 of the GPS/LW receiver circuit in accordance with the present invention. This embodiment does not perform frequency upconversion of the LW analog signal, but rather utilizes a separate RF front-end circuit (or off the self transceiver) for separately generating the LW baseband signal. A common baseband circuit then receives a signal that is time multiplexed between the LW baseband signal and the GPS baseband signal.

The GPS receiver path of circuit 200 is analogous to that of circuit 100 and includes GPS antenna 180, GPS saw filter 175 and GPS LNA circuit 170. Switch 195 (FIG. 1) is eliminated in circuit 200 and therefore, LNA circuit 170 provides the 1.57542 GHz GPS analog signal to optional gain circuit 310 (e.g., Gmax=12 dB; NF=3.0 dB) which is then filtered by saw filter circuit 120 (e.g., −1.5 dB) and provided to an RF front-end circuit 115, e.g., GPS radio chip U-Nav 8021, in one example. The output of the RF front-end circuit 115 is a GPS baseband signal of lines 340.

The LW receiver path of circuit 200 includes its own RF front-end circuit 325 which generates an LW baseband signal over lines 330. Alternatively, the LW baseband signal may be produced from a commercially available RF transceiver circuit. According to FIG. 3A, RF antenna 150 is coupled to saw filter 145 which is then coupled to a standard RF receiver circuit 320, as is well known in the art. Receiver circuit 320 provides a 900 MHz analog LW signal to the RF front-end circuit 325.

Multiplexer circuit 345 receives the LW baseband signal over lines 330 at one input and also receives the GPS baseband signal over lines 340 at another input. The output lines 235 of the multiplexer 345 are coupled to a common baseband circuit 110. The select input of the multiplexer 345 is controlled by line 350 which toggles between GPS mode and LW mode. In GPS mode, GPS baseband signal of lines 340 is supplied to circuit 110. In LW mode, LW baseband signal of lines 330 is supplied to circuit 110. Baseband circuit 110 operates in an analogous fashion to the baseband circuit of receiver 100 and recovers GPS data when in GPS mode and recovers LW data when in LW mode. This digital data can be provided over line 240 to downstream circuitry or used internally.

FIG. 3B illustrates another embodiment 200′ of a GPS/LW receiver circuit in accordance with the present invention. In some cases, the gain from the signals received directly from the GPS antenna 180 and from the RF antenna 150 can be sufficient to directly feed into a single RF front end circuit 115. Therefore, the LNA and saw filter circuits 392a and 392b are optional on each of the GPS and LW legs of the circuit 200′. A switch circuit 396 controlled by a switch signal 394 controls the selection of either the GPS or LW legs. Also, the single RF front end circuit 115 can be programmed to tune either GPS or LW frequency according to a tuner signal 390. the single RF front end circuit supplies a time multiplexed baseband signal to the baseband circuit 110 which recovers GPS digital and LW digital signals which are time multiplexed according to the tuner signal 390. This information may be stored in memory.

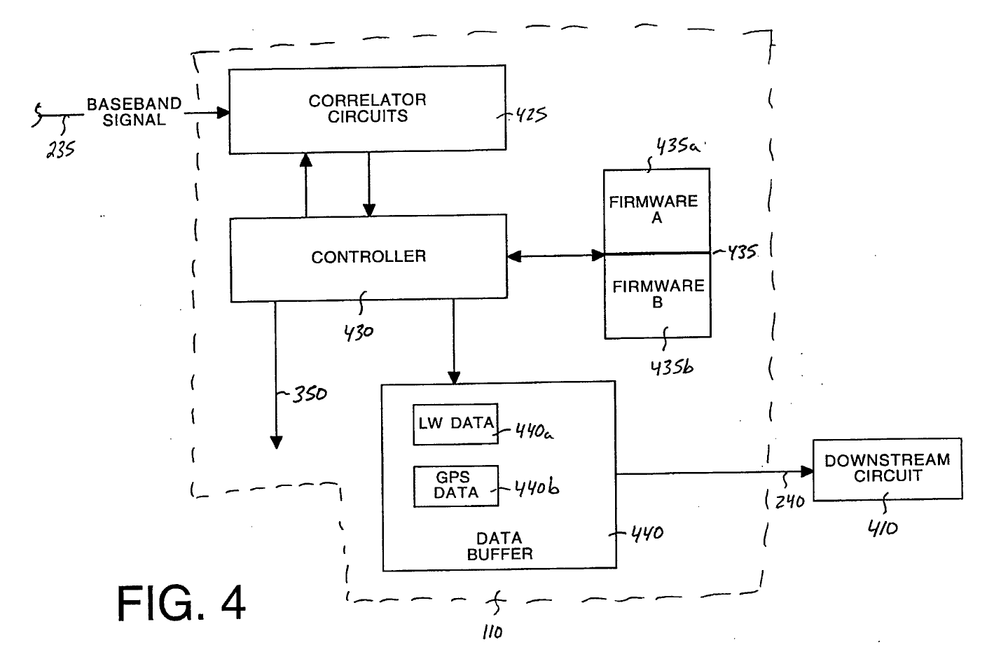

FIG. 4 illustrates relevant portions of the baseband circuit 110 in accordance with the embodiments of the present invention as shown in FIG. 2 and FIG. 3A and FIG. 3B. As discussed with respect to GPS/LW receiver circuits 100 and 200, inputs 235 carry time multiplexed baseband signals. During GPS mode, inputs 235 are GPS baseband signals and during LW mode they are LW baseband signals. The baseband signals are supplied to correlator circuits 425 which are controlled by a processor or controller 430. A microprocessor may be used. Microprocessor 430 generates the GPS/LW mode signal over line 350, in one embodiment. It is appreciated that microprocessor 430 may also be located external to circuit 110. Microprocessor 430 controls the operation of the correlators, loads them, resets them, causes them to sequence and checks the results of their counters to despread the baseband signal and recover therefrom the GPS or LW digital data. It is appreciated that the correlator circuitry 425 is shared between the GPS receiver path and the LW receiver path in accordance with embodiments of the present invention.

Memory 435 contains firmware code A 435a and firmware code B 435b in accordance with one embodiment. Firmware code A is used during GPS mode to control processor 430 and correlator circuits 425 to recover GPS digital data from the GPS baseband signal using conventional GPS communication protocols. Firmware code B is used during LW mode to control processor 430 and correlator circuits 425 to recover LW digital data from the LW baseband signal using LW communication protocols.

As discussed previously, LW communication protocols in one embodiment may be analogous to GPS recovery techniques. In another embodiment, LW communication may eliminate much of the GPS protocol overhead that is otherwise not required for LW data communication and may also reduce the amount of signal repetition used by GPS communication in an effort to optimize LW data communication.

FIG. 4 also illustrates an exemplary data buffer 440 for storing recovered LW digital data 440a and recovered GPS digital data 440b. This information may be consumed directly by the microprocessor 430 or provided to optional downstream circuits 410 via bus 240.

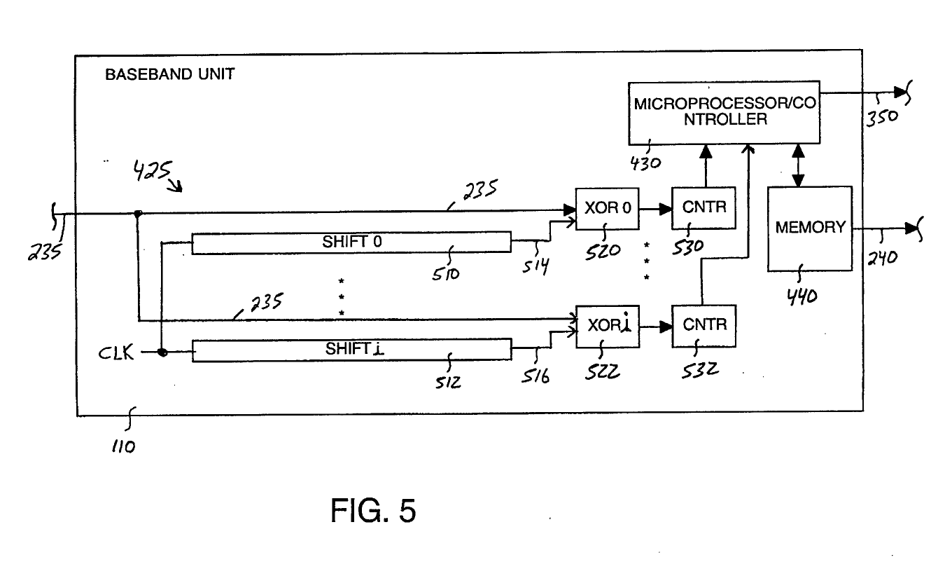

FIG. 5 illustrates components of the correlator circuitry 425 in more detail. As is well known, correlator circuits contain multiple commonly clocked shift registers, e.g., register 0 510 through register i 512 that are used for despreading. These shift registers are loaded with a locally generated replica of a gold code (e.g., a multi-bit binary number) that matches the gold code of the transmitter. The microprocessor 430 controls the loading of the shift registers. Each shift register presents bits of this gold code in a slightly time shifted manner to a separate XOR circuit, e.g., XOR 0 520 through XOR i 522. The XOR circuits also commonly receive the digital baseband signal as input 235 and therefore compare this baseband signal against the time shifted outputs of the shift registers as each locally generated bit is clocked out from the shift register. The XOR circuit responds to differences and generates an output when the two digital signals are not equal. Each output increases the count of a corresponding counter circuit, e.g., counters 530 and 532, which can be read by the microprocessor 430.

If a locally generated replica of the gold code from one of the shift registers closely matches (correlates) the received baseband signal, then its corresponding counter will have a very low count and will be detected by the microprocessor (this represents a 1 data bit) after one sequence length. Alternatively, if a locally generated replica of the gold code from one of the shift registers does not closely match(correlates) the received baseband signal, then its corresponding counter will have a very high count and will be detected by the microprocessor (this represents a 0 data bit). In each case, the counts in the other counters should be roughly equal and near a mid range distribution. Once a data bit is recovered, it is stored in memory 440. The microprocessor 430 may also perform demodulation as it may be required for the GPS or LW communication protocols.

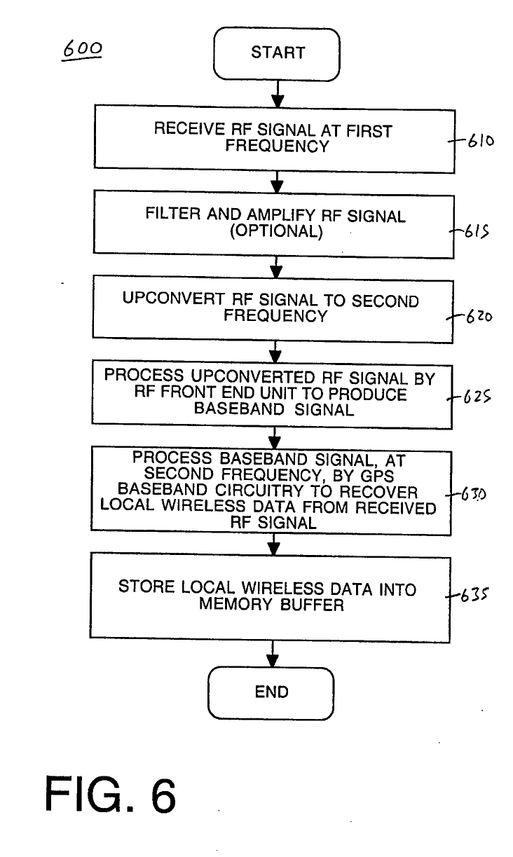

FIG. 6 illustrates a flow diagram of a process 600 of receiving GPS and LW wireless data in accordance with GPS/LW receiver 100. According to process 600, the analog RF signal of the local wireless communication path is upconverted so that it can be fed into shared RF front-end and baseband circuitry that are traditionally used only by the GPS receiver path.

At step 610 of FIG. 6, an RF analog signal is received at a first frequency, e.g., 900 MHz, and represents LW data. The RF signal is received using an inexpensive, low power, LNA circuit. The LW data may represent wireless communication between two finder devices, between a finder device and a tag, or between two tags, for instance. At step 615, this first analog LW signal may be filtered and may be amplified as required. At step 620, the first analog LW signal is upconverted to a second frequency. The upconverted signal is a second analog LW signal. In one embodiment, this second frequency matches the frequency used by GPS systems for wireless communication. In one embodiment, this second frequency is 1.57542 GHz. It is appreciated that in cases when the LW frequency is actually higher than the GPS frequency, the up conversion step 620 actually performs a down conversion function.

At step 625, the upconverted or second analog LW signal is then converted to a baseband signal, e.g., by being processed by an RF front end circuit. At step 630, in accordance with the present invention, the baseband signal generated by step 625 is then processed by a GPS baseband circuit which recovers LW digital data therefrom. The GPS baseband circuit may also be used by a GPS receiver path for recovering GPS digital data from a GPS baseband signal that may be time multiplexed with the LW baseband signal (which was generated at step 625). At step 645, the recovered LW digital data is stored in a memory buffer. By utilizing the GPS correlator circuits of the GPS baseband circuit for despreading the LW baseband signal, a very inexpensive and low power RF receiver circuit can be used for the LW receiver path.

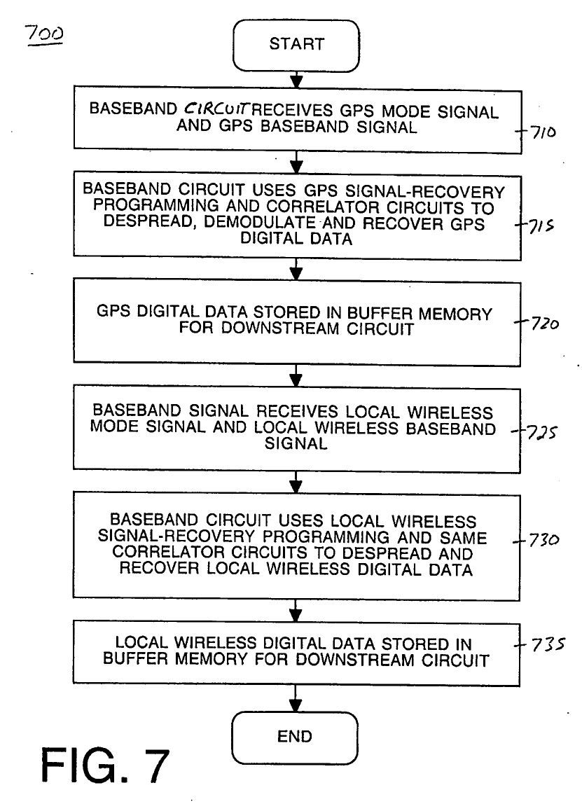

FIG. 7 illustrates a flow diagram of a process 700 of recovering GPS and LW wireless data in accordance with GPS/LW receiver 100 and GPS/LW receiver 200. According to process 700, it is assumed that two baseband signals are available, a GPS baseband signal and an LW baseband signal. They can be of the same frequency, e.g., 1.57542 GHz. At step 710, a common baseband circuit receives a GPS baseband signal in response to a mode signal indicating that the receiver is to recover GPS digital data. At step 715, the common baseband circuit executes processor instructions, e.g., firmware, in accordance with a well known GPS communication protocol to despread and demodulate the GPS baseband signal. GPS digital data is then recovered and stored in a buffer memory at step 720.

At step 725, the common baseband circuit receives an LW baseband signal in response to a mode signal indicating that the receiver is to recover LW digital data. At step 730, the common baseband circuit executes processor instructions, e.g., firmware, in accordance with a communication protocol to despread the LW baseband signal. These instructions may be different from the instructions used to recover the GPS digital data. LW digital data is then recovered and stored in a buffer memory at step 735.

In one embodiment, the firmware used at step 715 may be the same as the firmware used in step 730 because the recovery of LW digital data follow the GPS communication protocol. In this embodiment, the LW transmitter merely encodes the LW data according to the GPS protocol. In an alternative embodiment, an optimized communication protocol can be used which eliminates GPS protocol overhead and signal bit repetitions. In such a case, different firmware may be used between step 715 and step 730. The mode signal may switch between these firmware.

It is appreciated that at step 730, depending on the manner in which the local wireless data is encoded, the GPS signal-recovery programming of the baseband circuit may be used to recover local wireless data from the LW signal. In this case, the local wireless data is encoded using substantially the same data encoding format as is used by GPS systems. Therefore, the GPS recovery programming operates sufficiently to recover both GPS data, e.g., from the GPS signal and local wireless data, e.g., from the LW signal. In such case, there is no need to reprogram the signal recovery functions of the baseband circuit between GPS and LW modes. In this embodiment, the GPS programmed correlator circuits are used to recover LW data which is encoded using substantially a GPS data format.

The foregoing descriptions of specific embodiments of the present invention, a method and receiver device sharing GPS correlator circuitry to despread and recover local wireless data in addition to despreading and recovering GPS data thereby allowing an inexpensive local wireless receiver path, have been presented for purpose of illustration and description. They are not intended to be exhaustive or to limit the invention to the precise form disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A receiver device comprising:
a radio frequency (RF) front-end circuit for producing a GPS baseband signal from a received wireless analog GPS signal and for producing a local wireless (LW) baseband signal from a received wireless analog LW signal; and
a common baseband circuit coupled to said radio frequency front-end circuit to receive both said GPS and said LW baseband signals and for recovering therefrom GPS and LW digital data.

2. A receiver device as described in claim 1 wherein said GPS and said LW baseband signals are substantially 1.57542 GHz in frequency.

3. A receiver device as described in claim 2 wherein said received wireless analog LW signal has a frequency of substantially 900 MHz.

4. A receiver device as described in claim 1 wherein said common baseband circuit comprises common correlator circuitry that is used for despreading both said GPS said LW baseband signals for recovering digital data therefrom.

5. A receiver device as described in claim 4 wherein said common baseband circuit is operable in a first mode wherein said common correlator circuitry despreads said LW baseband signal and is operable in a second mode wherein said common correlator circuitry despreads said GPS baseband signal.

6. A receiver device as described in claim 5 wherein said common baseband circuit further comprises:
a processor for controlling said common correlator circuitry; and
a memory comprising: first processor code for operating said common baseband circuit according to a first communication protocol during said first mode; and second processor code for operating said common baseband circuit according to a second communication protocol during said second mode.

7. A receiver device as described in claim 6 wherein said memory is operable for storing said LW digital data and said GPS digital data.

8. A receiver device comprising:
a first receiver circuit for coupling with an antenna and for receiving and reproducing an analog global positioning system (GPS) signal therefrom having a first frequency;
a radio frequency (RF) front-end circuit for receiving said analog GPS signal and for producing a GPS baseband signal therefrom;
a frequency converter circuit for converting a first analog LW signal having a second frequency to a second analog LW signal having said first frequency,
wherein said RF front-end circuit also receives said second analog LW signal and produces an LW baseband signal therefrom; and
a baseband circuit for receiving both said GPS and said LW baseband signals and recovering therefrom GPS and LW data.

9. A receiver device as described in claim 8 further comprising a second receiver circuit for coupling with an antenna and coupled to said frequency converter circuit, said second receiver circuit for receiving and reproducing said first analog local wireless (LW) signal having said second frequency.

10. A receiver device as described in claim 9 wherein said second receiver circuit comprises a low noise amplifier circuit.

11. A receiver device as described in claim 10 wherein said second receiver circuit further comprises a filter circuit.

12. A receiver device as described in claim 9 wherein said first frequency is substantially 1.57542 GHz.

13. A receiver device as described in claim 12 wherein said second frequency is a radio frequency.

14. A receiver device as described in claim 13 wherein said second frequency is substantially 900 MHz.

15. A receiver device as described in claim 9 wherein said baseband circuit comprises correlator circuitry that is used for despreading both said GPS said LW baseband signals for recovering data therefrom.

16. A receiver device as described in claim 15 wherein said baseband circuit is operable in a first mode wherein said correlator circuitry despreads said LW baseband signal and is operable in a second mode wherein said correlator circuitry despreads said GPS baseband signal.

17. A receiver device as described in claim 16 wherein said baseband circuit further comprises:
a processor for controlling said correlator circuitry; and
a memory comprising: first processor code for operating said baseband circuit according to a first communication protocol during said first mode; and second processor code for operating said baseband circuit according to a second communication protocol during said second mode.

18. A receiver device as described in claim 17 wherein said memory is operable for storing said LW data and said GPS data.

19. A receiver device as described in claim 9 wherein said frequency converter circuit comprises: a mixer circuit; and a phase lock loop circuit, and wherein further, said frequency converter circuit outputs said second analog LW signal.

20. A receiver device as described in claim 16 further comprising a switch coupled to receive said analog GPS signal and said second analog LW signal, said switch for passing through said second analog LW signal to said RF front-end circuit during said first mode and for passing through said analog GPS signal to said RF front-end circuit during said second mode.

21. A method of receiving wireless data signals comprising:
receiving an analog global positioning system (GPS) signal from an antenna, said analog GPS signal having a first frequency;
producing a GPS baseband signal from said analog GPS signal;
receiving a first analog local wireless (LW) signal from an antenna, said first analog LW signal having a second frequency;
converting said first analog LW signal to a second analog LW signal having said first frequency;
producing an LW baseband signal from said second analog LW signal; and
supplying both said GPS and said LW baseband signals to a common baseband circuit and recovering them from GPS and LW data using said common baseband circuit.

22. A method as described in claim 21 wherein said receiving a first analog LW signal is performed by a receiver circuit which comprises a low noise amplifier circuit.

23. A method as described in claim 21 wherein said first frequency is substantially 1.57542 GHz and wherein said second frequency is a radio frequency.

24. A method as described in claim 23 wherein said second frequency is substantially 900 MHz.

25. A method as described in claim 21 wherein said common baseband circuit comprises common correlator circuitry and wherein further said recovering comprises despreading both said GPS said LW baseband signals using said common correlator circuitry.

26. A method as described in claim 25 wherein said despreading comprises:
despreading in a first mode wherein said common baseband circuit is supplied said LW baseband signal and wherein further said common correlator circuitry despreads said LW baseband signal; and
despreading in a second mode wherein said common baseband circuit is supplied said GPS baseband signal and wherein further said common correlator circuitry despreads said GPS baseband signal.

27. A method as described in claim 26 further comprising:
using a processor for controlling said despreading of said LW baseband signal according to a first communication protocol using first processor code; and
using said processor for controlling said despreading of said GPS baseband signal according to a second communication protocol using second processor code, wherein said common baseband circuit further comprises a memory storing said first processor code and said second processor code.

28. A method as described in claim 26 wherein said producing a GPS baseband signal from said analog GPS signal is performed by an RF front-end circuit and wherein further said producing an LW baseband signal from said second analog LW signal is also performed by said RF front-end circuit and further comprising time multiplexing said analog GPS signal and said second analog LW signal to said RF front-end circuit using a switch.

29. A receiver device comprising:
a first radio frequency (RF) front-end circuit for producing a GPS baseband signal from a received wireless analog GPS signal;
a second RF front-end circuit for producing a local wireless (LW) baseband signal from a received wireless analog LW signal; and
a common baseband circuit for receiving both said GPS and said LW baseband signals and for recovering therefrom GPS and LW digital data.

30. A receiver device as described in claim 29 wherein said GPS and said LW baseband signals are substantially 1.57542 GHz in frequency.

31. A receiver device as described in claim 30 wherein said received wireless analog LW signal has a frequency of substantially 900 MHz.

32. A receiver device as described in claim 29 wherein said common baseband circuit comprises common correlator circuitry that is used for despreading both said GPS said LW baseband signals for recovering digital data therefrom.

33. A receiver device as described in claim 32 wherein said common baseband circuit is operable in a first mode wherein said common correlator circuitry despreads said LW baseband signal and is operable in a second mode wherein said common correlator circuitry despreads said GPS baseband signal.

34. A receiver device as described in claim 33 wherein said common baseband circuit further comprises:
a processor for controlling said common correlator circuitry; and
a memory comprising: first processor code for operating said common baseband circuit according to a first communication protocol during said first mode; and second processor code for operating said common baseband circuit according to a second communication protocol during said second mode.

35. A receiver device as described in claim 34 wherein said memory is operable for storing said LW digital data and said GPS digital data.

36. A receiver device as described in claim 33 further comprising a switch coupled to receive signals from said first and second RF front-end circuits and coupled to supply signals to said common baseband circuit, said switch for passing through said LW baseband signal during said first mode and for passing through said GPS baseband signal during said second mode.

37. A method of receiving wireless data signals comprising:
producing a GPS baseband signal from a received wireless analog GPS signal;
producing a local wireless (LW) baseband signal from a received wireless analog LW signal;
supplying said GPS baseband signal and said LW baseband signal to a common baseband circuit; and
recovering GPS and LW digital data by using said common baseband circuit to perform despreading of both said GPS and said LW baseband signals.

38. A method as described in claim 37 wherein said GPS and said LW baseband signals are substantially 1.57542 GHz in frequency.

39. A method as described in claim 38 wherein said received wireless analog LW signal has a frequency of substantially 900 MHz.

40. A method as described in claim 37 wherein said producings are performed using a first RF front-end circuit and a second RF front-end circuit, respectively.

41. A method as described in claim 37 wherein said common baseband circuit comprises common correlator circuitry and wherein said despreading comprises using said common correlator circuitry to despread both said GPS said LW baseband signals for recovering digital data therefrom.

42. A method as described in claim 41 wherein said despreading further comprises:
despreading in a first mode wherein said common baseband circuit is supplied said LW baseband signal and wherein further said common correlator circuitry despreads said LW baseband signal; and
despreading in a second mode wherein said common baseband circuit is supplied said GPS baseband signal and wherein further said common correlator circuitry despreads said GPS baseband signal.

43. A method as described in claim 42 further comprising:
using a processor for controlling said despreading of said LW baseband signal according to a first communication protocol using first processor code; and
using said processor for controlling said despreading of said GPS baseband signal according to a second communication protocol using second processor code, wherein said common baseband circuit further comprises a memory storing said first processor code and said second processor code.

44. A method as described in claim 42 further comprising time multiplexing said GPS baseband signal and said LW baseband signal to said common baseband circuit using a switch.

45. A method of recovering data comprising:
reproducing a local wireless analog signal carrying local wireless digital data encoded therein, said local wireless digital data being encoded using a substantially GPS data encoding format;
generating a first baseband signal based on said local wireless analog signal; and
recovering said local wireless digital data from said first baseband signal by despreading said first baseband signal using data recovery procedures that are substantially compliant with GPS data recovery procedures.

46. A method as described in claim 45 further comprising:
reproducing a GPS analog signal carrying GPS digital data encoded therein;
generating a second baseband signal based on said GPS analog signal; and
recovering said GPS digital data from said second baseband signal by despreading said second baseband signal.

47. A method of recovering data as described in claim 46 wherein said recovering is performed by a baseband circuit that recovers both said GPS digital data and said local wireless digital data.
